(19) United States
(12) Patent Application Publication
(10) Pub. No.: US 2025/0363845 A1
(43) Pub. Date: Nov. 27, 2025

(54) PASSENGER JOURNEY AUTHORISATION SYSTEM AND METHOD

(71) Applicant: SITA Advanced Travel Solutions Limited, Aldershot (GB)

(72) Inventors: Steven MCLAUCHLAN, Hayes Middlesex (GB); Naga Kishore Kumar MOVVA, Hayes Middlesex (GB); Alastair LAMB, Hayes Middlesex (GB); Ryszard SKOBELSKI, Hayes Middlesex (GB)

(21) Appl. No.: 19/231,953

(22) Filed: Jun. 9, 2025

Related U.S. Application Data
(63) Continuation of application No. PCT/GB2022/053346, filed on Dec. 21, 2022.

(51) Int. Cl. G07C 9/22; G06Q 10/02

(52) U.S. Cl. CPC G07C 9/22; G06Q 10/02; G07C 2209/41

(57) ABSTRACT

A system and method for authorising a passenger journey are described. Passengers travelling from an origin country to a destination country, obtain one or more travel authorisation documents that permit the passenger to travel to the destination country by being issued a set of predetermined questions relating to the passenger journey. Information associated with the passenger journey is compared with one or more risk parameters to determine a score, that is then used to determine a travel authorisation outcome. A travel authorisation document may then be issued to the passenger based on the travel authorisation outcome.

### CROSS-REFERENCE TO RELATED APPLICATION

This application is a continuation of International Patent Application PCT/GB2022/053346, filed on Dec. 21, 2022, and entitled “PASSENGER JOURNEY AUTHORISATION SYSTEM AND METHOD,” the contents of which are incorporated by reference in their entirety as if set forth herein.

### FIELD OF INVENTION

The invention relates to a system and method for authorising a passenger journey from an origin to a destination, particularly for use in screening travellers for an Electronic Travel Authorisation system.

### BACKGROUND

Border control systems and processes relate to managing the passage of individuals across national borders with high levels of accuracy and security. Many countries have implemented travel authorisation systems as part of their border control systems, in order to enable travellers to be screened before arrival. This process typically involves passengers completing one or more travel declarations in advance of arriving at a destination. Some countries also require visitors to complete landing cards in order to provide supplementary information, such as the purpose of the visit, final destination, and the address where the traveller will be staying.

These travel declarations enable destination country agencies to provide travel authorization documents, such as health, customs or immigration travel declarations, to enable a passenger to travel to the destination country, before conducting further checks on arrival to determine whether the passenger is eligible to enter the destination country.

At present, many of these travel declarations and landing cards are completed using pen and paper. There is a need to enable the automation of completing travel declarations and issuing travel authorisation documents to reduce the amount of manual checks that must be conducted by destination country border control agents, and so reduce delays to the passenger journey.

### SUMMARY OF INVENTION

The invention is defined by the independent claims, to which reference should now be made. Preferred features are set out in the dependent claims.

In a first aspect of the invention, a system for authorising a passenger journey from an origin country to a destination country comprises a memory for storing computer readable code, and a processor operatively coupled to the memory, the processor configured to issue a set of predetermined questions relating to the passenger journey to a passenger before travelling to the destination country, receive information associated with the passenger journey, calculate a score associated with the passenger journey by comparing the information associated with the passenger journey to one or more risk parameters, compare the calculated score to a predetermined threshold value to determine a travel authorisation outcome, and issue, based on the travel authorisation outcome, a travel authorisation document to the passenger making the passenger journey.

Embodiments of the invention may have the advantage of automatically issuing one or more travel authorisation documents for allowing a passenger to travel to a destination country. The travel authorisation document may be digitally secure, and may be shared with external parties.

An embodiment of the invention further comprises a mobile device including the memory for storing computer readable code, the processor operatively coupled to the memory, a display and a receiver. This advantageously allows users to interface with the authorisation system in a convenient fashion using a mobile device. Additionally, functionality of the mobile device may be leveraged.

In another embodiment of the invention the passenger-related information including one or more images of the passenger's face. This advantageously allows the identity of the passenger to be verified.

In another embodiment of the invention the one more images include live images or video of the passenger's face. This advantageously allows the system to verify the identity of the passenger by identifying spoofing attempts.

Another embodiment of the invention further comprises a passenger profile based on the passenger-related information, the passenger profile including one or more of passport data, live face image data, and digital travel credentials (DTD). This advantageously allows the efficient management and storage of information related to the passenger.

In another embodiment of the invention the processor is further configured to authorise the passenger journey if the calculated score is less than the predetermined threshold value. This advantageously allows for a travel authorisation outcome to be determined automatically based on a set of answers provided by the passenger.

In another embodiment of the invention the predetermined questions are a set of configurable questions related to the health, customs and/or immigration status of the passenger. This advantageously allows the system to be configured and adapted for a number of different use cases, and allows the passenger to make multiple travel declarations for the same journey.

In another embodiment of the invention the travel authorisation document is a health declaration for determining whether the passenger is medically suitable for travel. This advantageously allows the passenger to automatically obtain a health declaration from a destination government.

In another embodiment of the invention the information associated with the health declaration is anonymised. This advantageously allows sensitive information relating to the health of a passenger to remain confidential.

In another embodiment of the invention the information associated with the passenger journey includes one or more of passenger-related information, information associated with one or more health tests, information associated with one or more recent vaccinations, information associated with symptoms indicative of one or more diseases, and information associated with one or more pre-existing health conditions. This advantageously allows health declarations to be issued automatically.

In another embodiment of the invention the travel authorisation document is a customs declaration for determining whether the passenger journey will incur customs duties. This advantageously allows the passenger to automatically obtain a customs declaration from a destination government.

In another embodiment of the invention the information associated with the passenger journey includes one or more of passenger-related information, flight-related information, information associated with value of goods being brought into arrival country, and information associated with controlled goods or substances subject to regulation by the arrival country. This advantageously allows customs declarations to be issued automatically.

In another embodiment of the invention the travel authorisation document is an immigration declaration for determining the immigration status of the passenger. This advantageously allows the passenger to automatically obtain an immigration declaration from a destination government.

Another embodiment of the invention further comprises a database for storing the information associated with the passenger journey, travel authorisation outcome and travel authorisation document in a database. This advantageously allows relevant information and documents to be shared with other parties.

Another embodiment of the invention further comprises a token associated with the passenger journey, the token configured to allow a user to access at least part of the stored passenger-related information and travel authorisation outcome. This advantageously allows relevant information and documents to be shared with other parties without granting access to all information and documents, some of which may be sensitive.

In another embodiment of the invention the token is a QR code, or a reference number. This advantageously allows access to relevant information and documents to be shared in an efficient manner.

In another embodiment of the invention the stored passenger-journey information and travel authorisation outcome associated with the passenger journey are assigned a unique GUID. This advantageously allows relevant information and documents associated with the same passenger to be collated and uniquely identified.

In another embodiment of the invention the information associated with the passenger journey includes passenger-related information.

Another embodiment of the invention further comprises a browser application or mobile application for obtaining the information associated with the passenger journey. This advantageously allows a user to access the system through web-based devices or mobile devices.

Another embodiment of the invention further comprises an optical character recognition (OCR) system for obtaining the passenger-related information from one or more travel identity documents associated with the passenger. This advantageously allows data from a travel document to be extracted optically.

Another embodiment of the invention further comprises a Near Field Communications (NFC) system for obtaining the passenger-related information from one or more travel identity documents associated with the passenger. This advantageously allows data from a travel document to be extracted electronically.

Another embodiment of the invention further comprises a check-in system configured to prevent the passenger from checking in for the journey if authorisation for the passenger journey is denied. This advantageously prevents a passenger from being able to make a journey to a destination country if they have not obtained the relevant travel authorisation documents.

In a second aspect of the invention, a method for authorising a passenger journey from an origin country to a destination country comprises issuing, to a passenger before travelling to the destination country, a set of predetermined questions relating to the passenger journey, receiving, in response to the set of questions, information associated with the passenger journey, calculating a score associated with the passenger journey by comparing the information associated with the passenger journey to one or more risk parameters, comparing the calculated score to a predetermined threshold value to determine a travel authorisation outcome, and issuing, based on the travel authorisation outcome, a travel authorisation document to the passenger thereby enabling the passenger to undertake the passenger journey.

The advantages associated with the second aspect of the invention are the same as those recited above for the first aspect of the invention.

An embodiment of the invention further comprises authorising the passenger journey if the calculated score is less than the predetermined threshold value.

In another embodiment of the invention the travel authorisation document is a health declaration for determining whether the passenger is medically suitable for travel.

In another embodiment of the invention the information associated with the health declaration is anonymised.

In another embodiment of the invention the information associated with the health declaration is deleted after a predetermined interval of time. This advantageously allows sensitive information relating to the health of a passenger to be purged from the system after a certain amount of time has elapsed.

In another embodiment of the invention the information associated with the passenger journey includes one or more of passenger-related information, information associated with one or more health tests, information associated with one or more recent vaccinations, information associated with symptoms indicative of one or more diseases, and information associated with one or more pre-existing health conditions.

In another embodiment of the invention the travel authorisation document is a customs declaration for determining whether the passenger journey will incur customs duties.

In another embodiment of the invention the information associated with the passenger journey includes one or more of passenger-related information, flight-related information, information associated with value of goods being brought into arrival country, and information associated with controlled goods or substances subject to regulation by the arrival country.

In another embodiment of the invention the travel authorisation document is an immigration declaration for determining the immigration status of the passenger.

Another embodiment of the invention further comprises storing the information associated with the passenger journey, travel authorisation outcome and travel authorisation document in a database.

Another embodiment of the invention further comprises issuing a token associated with the passenger journey for allowing a user to access at least part of the stored passenger-related information and travel authorisation outcome.

In another embodiment of the invention the token is a QR code, or a reference number.

In another embodiment of the invention a unique GUID is assigned to the stored passenger-journey information and travel authorisation outcome associated with the passenger journey.

In another embodiment of the invention the information associated with the passenger journey includes passenger-related information.

Another embodiment of the invention further comprises obtaining, via a browser application or mobile application, the information associated with the passenger journey.

Another embodiment of the invention further comprises obtaining, via an optical character recognition (OCR) system, the passenger-related information from one or more travel identity documents associated with the passenger.

Another embodiment of the invention further comprises obtaining, via a Near Field Communications (NFC) system, the passenger-related information from one or more travel identity documents associated with the passenger.

Another embodiment of the invention further comprises obtaining the passenger-related information via a mobile device, the passenger-related information including one or more images of the passenger's face

In another embodiment of the invention the one more images include live images or video of the passenger's face.

Another embodiment of the invention further comprises verifying the passenger based on the passenger-related information.

Another embodiment of the invention further comprises a passenger profile based on the passenger-related information, the passenger profile including one or more of passport data, live face image data, and digital travel credentials (DTD).

Another embodiment of the invention further comprises obtaining, via one or more external systems, the information associated with the passenger journey, the one or more external systems including a passenger name record (PNR), check in system, flight information system, or a health declaration system.

In another embodiment of the invention the travel authorisation document is transmitted via a mobile application, email, SMS, or other suitable means of communication. This advantageously allows passengers to be provided with electronic or physical copies of the travel authorisation document for providing to agents at the destination country.

Another embodiment of the invention further comprises authenticating the passenger using a personal identification number (PIN) and/or biometric data associated with the passenger. This advantageously allows the identity of passengers to be verified.

Another embodiment of the invention further comprises associating the PIN and/or biometric data with a token associated with the passenger journey. This advantageously allows the passenger to securely access information and documents associated with the passenger journey.

### DETAILED DESCRIPTION

Embodiments of the invention will now be described, by way of example only, with reference to the accompanying drawings, in which:

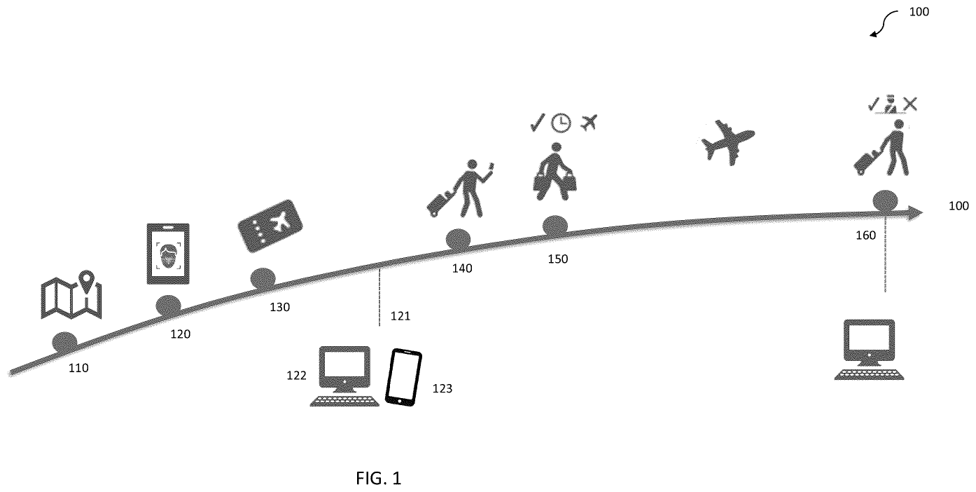

FIG. 1 shows a schematic diagram of a passenger journey;

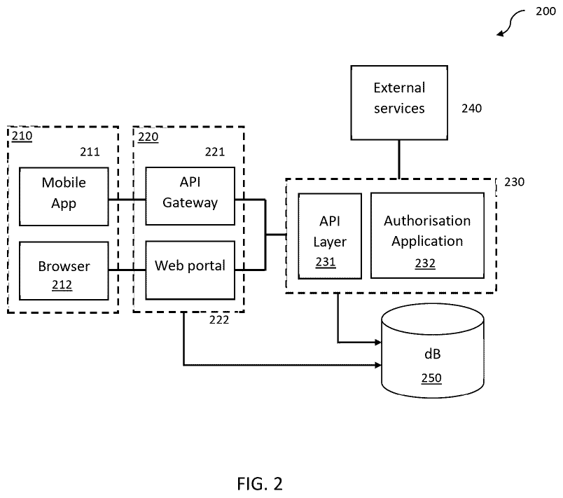

FIG. 2 shows a schematic diagram of an example travel authorisation system;

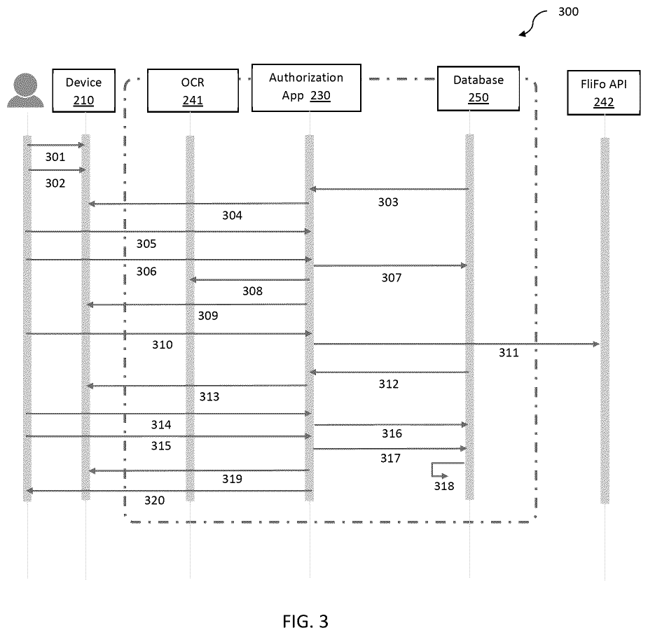

FIG. 3 shows a schematic diagram of an example travel authorisation process; and

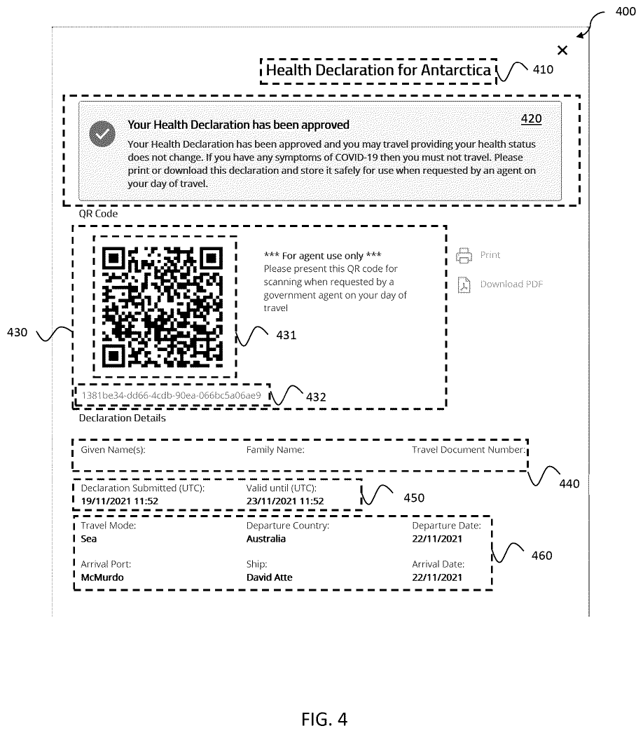

FIG. 4 shows a schematic diagram of an example travel authorisation document.

Embodiments of the invention described below relate to providing travel authorisation documents to passengers in advance of a passenger journey. Although the embodiments described below relate to passengers travelling by air, it will be appreciated that the invention is not limited to such embodiments and may equally relate to passenger journeys undertaken by land or sea.

Many countries have implemented border control measures that require passengers to complete travel declarations before being allowed entry to the country. Typical travel declarations may include a customs declaration, which indicates whether any items brought into the destination country are subject to cross-border customs taxes, an immigration declaration, which indicates whether a passenger is entitled to enter or remain in the destination country, and a health declaration, which indicates whether a passenger is medically fit and/or symptomatic of one or more diseases.

To ameliorate the amount of time required for agents at the destination country to review the travel declaration documents, and thus prevent delays during a passenger journey, aspects of the invention enable a passenger to make one or more travel declarations that are automatically analysed in order to provide a travel authorisation document that allows the passenger to travel to the destination country, as further described below with reference to FIG. 1.

FIG. 1 shows a schematic diagram of a passenger journey 100 in accordance with embodiments of the invention.

In FIG. 1, the passenger journey 100 comprises the steps of a passenger planning a journey 110, the passenger making one or more travel declarations 120, the passenger booking the journey 130, the passenger checking in at the origin country 140, the passenger boarding a flight or other means of transportation 150 in order to travel to the destination country, and the passenger undergoing immigration checks at the destination country 160. Although these steps are schematically shown in loose chronological order, it will be appreciated that some events may not happen in the order shown in FIG. 1. For example, the passenger may complete the one or more travel declarations after the journey is booked.

According to aspects of the invention, as described further below, step 120 relating to making one or more travel declarations comprises the steps of issuing the passenger with a set of predetermined questions, the passenger providing information 121 in response to the set of predetermined questions, using a processor 122 to perform a risk assessment to determine whether the passenger should be permitted to travel to the destination country, and issuing the passenger with a notification 123 with the outcome of the risk assessment. The predetermined questions relate to aspects of the journey from the origin country to the destination country, including details relating to the passenger. The risk calculation involves calculating a score associated with the passenger journey by comparing the information provided by the passenger to one or more risk parameters, and comparing the score to a predetermined threshold value. If the travel authorisation outcome is that the passenger is approved to travel to the destination country, the passenger is also issued with a travel authorisation document enabling the passenger to travel to the destination country.

Optionally, for cases that require manual intervention, the travel declarations may be reviewed by an agent to determine whether the passenger is authorised to travel to the destination country. In such instances, the passenger will be issued with a notification with a travel authorisation outcome and, depending on the outcome, a travel authorisation document.

During step 160, an immigration officer at the destination country may retrieve the status of the passenger's travel declaration and access any travel authorisation documents by accessing a web portal, mobile application, or other access point. Accordingly, the immigration officer does not have to spend as much time reviewing the travel declarations, which reduces travel delays due to lengthy queues at immigration. The immigration officer then may perform verification of the identity of the passenger and make a decision whether to allow the passenger to enter the destination country. In some embodiments, biometric data associated with the passenger may be associated with the travel declaration and authorisation documents, as further described below, and so the immigration office may use the stored biometric data to verify the identity of the passenger.

FIG. 2 shows a schematic diagram of an example authorisation system 200 in accordance with embodiments of the invention.

In FIG. 2, the authorisation system 200 comprises a user device 210, a user device interface 220, an authorisation application 230, one or more external services 240, and a database 250.

The user device 210 may include a mobile application 211 or a web browser 221 that allow a user to access the authorisation application 230. The mobile application or web browser communicate with the user device interface 220, which includes an API Gateway 212 for interfacing with the mobile application and/or a web portal 222 for interfacing with the web browser such that the mobile application and/or web portal can communicate with the authorisation application 230.

The mobile application 211 may include one or more of a user management module, an identity module, a Digital Travel Credential (DTC) module, a location module, a visible data seal module, and a travel authorisation module.

In preferred embodiments, the passenger may only access the functionality of the mobile app 211 by creating a user account. In such embodiments, the mobile app 211 may require the passenger to create an account and sign-in to that account before using the app.

In order to access the features within the mobile app 211, the user must confirm their identity by using one or more of: a passcode, a fingerprint biometric, or a face biometric. In preferred embodiments, the password is a 6-digit passcode, which is associated with the account and not an associated mobile device. In preferred embodiments, the native authentication capabilities of the mobile device are utilised to make use of the fingerprint biometric data and/or face biometric data.

The app 211 may provide functionality to enable the passenger to sign up, sign in, change a password and edit their user profile. This may be achieved by enabling the user management module to integrate with the one or more external systems 240 that includes an Identity Provider service via the API Gateway 221. The Identity Provider service may also provide an authentication token issuance service whereby on a successful user authentication the app will receive an ID token and a Refresh token. The short-lived ID token may be an access token (S2S token) used to authenticate service calls from the app 211 to the authorisation application 232, with the API Gateway 221 authenticating the ID token. The longer-lived Refresh token may be used to renew an expired ID token. The app 211 calls the Identity Provider service to renew the token via API Gateway 221. The app 211 may also use the Refresh token to provide a convenient login to the passenger using a PIN or biometric data.

Passengers can use the mobile app 211 to create a reusable user profile based on information obtained by providing information relating to a travel document, for example by scanning their travel document or reading the chip of the travel document. The passenger may also take a self-portrait image that is subject to liveness detection and quality checks, which then undergoes 1:1 face matching to verify a link between the travel document and the passenger that holds the travel document. An International Civil Aviation Organisation (ICAO) Digital Travel Credential (DTC) may also be created as part of the process which can then be further verified using ICAO Public Key Directory (PKD) and/or German Federal Office for Information Security (BSI) master lists.

In preferred embodiments, the information associated with the passenger profile may be stored on secure storage on the mobile device. In preferred embodiments, the information associated with the passenger profile includes one or more of: biographic data obtained from the chip of an electronic travel document or visual inspection zone (VIZ) page, including information about the travel document itself, such as the type of travel document; a photo obtained from the chip of an electronic travel document or VIZ page; a cropped photo from the VIZ page; a DTC, if available; and the personal number and/or national ID, if available.

Once the passenger has created a profile, which includes information related to a travel document (such as passport data), passenger-related information (such as a live-image of the passenger's face) and a Digital Travel Credential (DTC) associated with the information related to the passenger and the travel document, then the passenger may then proceed with making one or more travel declarations. In embodiments where the travel document is an ePassport, the DTC module creates a DTC from the content of the embedded chip.

In preferred embodiments, the Identity module of the mobile app 211 enables passengers to capture information associated with their travel document by using their mobile device to optically scan the information with a camera on the mobile device. If the travel document is an ePassport, then the information stored on a chip in the travel document may be read using an NFC sensor in the mobile device. The mobile device may be further used to capture live face image(s) of the passenger using liveness detection and quality assurance. In order to perform the liveness detection and quality assurance check, the mobile app 211 may send an API call via the API Gateway 420 to the one or more external services 240 to perform the liveness check and quality check.

A 1:1 verification between the travel document and the passenger may then be undertaken whereby an analytical comparison is made between the live-face image and travel document image.

In preferred embodiments, the Travel Authorisation module of the mobile app 211 registers travel documents, uploads supporting documents, and manages travel declarations.

The mobile app 211 may also cooperate with an external payment processor in order to accept payments with credit/debit cards, or any other suitable secure form of electronic payment system.

In preferred embodiments, the mobile application may use an external cloud based service to provide a push notification service for issuing notifications on Android® and iOS® devices. Each app instance is registered to the cloud service to get a unique push notification token. The token can be refreshed at discretion of the cloud provider. The app may register the associated mobile device for push notifications in known ways using push notification tokens to confirm when an applicant has submitted a travel declaration, and when the declaration has been approved or denied.

In preferred embodiments, the authorisation application 230 includes an API layer 231 and authorisation service 232 that cooperate with the one or more external services 240 and database 250 to provide the functionality of the authorisation service described below.

The one or more external services 240 may include an optical character recognition (OCR) service for converting an image of text into a machine-readable text format, a flight information service for providing information and status updates for flights from airports around the world, a passenger name record (PNR) for providing the itinerary for one or more passengers, a check in system for providing the details of passengers who have checked in for a scheduled flight, and a health data service for providing copies of patient medical records. However, it will be appreciated that the authorisation application 230 may be configured to include an OCR service such that the OCR service is not provided as an external service.

The one or more external services 240 may further include identity providers, authentication providers, application analytics, crash analysis, notifications, configurations, and/or external APIs. In some embodiments, the one or more external systems may include a service for collecting analytics, performance metrics and crash reports that does not include personally identifiable information (PII). This information enables an analysis of how the app is used and to identify any potential issues.

The database 250 is configured to store information, and may be located remotely to the authorisation application 230. In preferred embodiments, the database 250 is configured to store information associated with the passenger journey, a travel authorisation outcome and a travel authorisation document. In some embodiments, a unique GUID is assigned to the stored passenger-journey information and travel authorisation outcome associated with the passenger journey to enable the unique identification of information associated with a passenger journey.

In some embodiments, third parties such as government agents may access a subset of data stored on database 250. Stored travel authorisation documents, such as travel declarations, may be extracted by an external government system by providing the government system with an access token associated with a passenger journey. The government system may then request access to one or more travel declarations for a specified date and time range using one or more issued tokens. The status of declarations may also be shared with the external government system. Again, this may be achieved by issuing a token associated with a passenger journey, which enables the external government system to be issued with the latest declaration associated with the token.

FIG. 3 shows a schematic diagram of an example authorisation process 300 in accordance with embodiments of the invention. System components described above for FIG. 2 are provided with the same reference numbers in FIG. 3.

As shown in the example of FIG. 3, the authorisation process 300 may first obtain one or more travel documents associated with the passenger. In the context of the invention, it will be appreciated that a travel document may be a national identity document such as a passport, ePassport, or national identity card. In a first step 301 a passenger may sign up for, or log in to, the authorisation application 230 using a user device 210. In some embodiments, this may require the passenger creating a user account by providing an email address and the passenger being authenticated using a random verification code before the passenger is allowed access to the authorisation application 230. Once signed in, the passenger begins the process of creating a travel declaration in step 302. On initiating the travel declaration, the authorisation application 230 may retrieve any travel documents currently associated with the passenger that are stored in database 250 in step 303. In step 304, the authorisation application 230 provides the travel declaration form to the passenger along with any retrieved travel documents associated with the passenger. In some embodiments, the passenger provides their biographic data and travel documents and indicates whether they are completing the declaration for themselves or for someone else. In step 305, the passenger can confirm whether the retrieved travel document is still valid and, if not, provide a new or updated travel document in step 306. This may be achieved by manually providing information associated with the travel document, or by providing a scan or image of the travel document. In preferred embodiments, the information associated with the travel document may include one or more of a travel document type, passenger name, passenger date of birth, passenger nationality, passenger gender, the country or state that issued the travel document, the date of issue, and date of expiry. In step 307, the authorisation application 230 updates the database 250 with the details of the new travel document or with confirmation the existing travel document is still valid.

In step 308, the authorisation process 300 uses the travel document associated with the passenger to obtain passenger-related information. This may be achieved by the authorisation application 230 communicating with an OCR system 241, which may be located external to the authorisation system, in order to extract relevant data from the travel document, such as the full name of the passenger, an issuing country name, a passport number, and an expiry date for the travel document.

In further process steps, the authorisation system 200 verifies the information associated with the passenger journey. This may be achieved by the authorisation application 230 providing the passenger with a journey details form in step 309. The passenger provides information associated with the passenger journey, which may include one or more of the country of departure, country of arrival, date of departure, date of arrival, flight number, ship name, and land transportation details, which are provided to the authorisation application 230 in step 310. Depending on the mode of travel and departure country selected, the fields required to be completed by the passenger may change depending on whether the journey is by air, sea or land, and whether the journey is inbound or outbound to a host country that is issuing the declarations.

In step 311, the authorisation application 230 communicates with an external travel information system to validate the journey details provided by the passenger. For example, the authorisation application 230 may communicate with a flight information API 242 to validate the flight number, departure date and country of departure and arrival. In some embodiments, if the flight details cannot be found then the system asks the traveller to confirm the stated flight details. This allows the system to accommodate emergency charter flights that may not otherwise be entered into the flight information system. If the flight details are matched in the flight information system, but other details provided by the traveller do not match, then the system flags the discrepancies to the passenger to enable the passenger to correct any errors.

On successfully verifying the passenger journey, the authorisation system 200 provides the passenger with a set of questions to enable the passenger to make one or more travel declarations. This may involve the authorisation application 230 fetching a dynamic, or configurable, set of questions from database 250 in step 312, and providing those questions to the passenger via a user device 210 in step 313.

The questionnaire collects information from the passenger that enables the travel declaration to be completed, and uses a set of questions have been pre-configured for the host country. The questions may be configured within the questionnaire to be added, edited, deleted or moved. The questions may be displayed in sections, be conditional on a parent question such that subsequent questions provided to the passenger depend on the answers the passenger provides to one or more earlier questions, and the questions may comprise multiple elements to form a compound question. A question may be required immediately for the declaration to be submitted, optional, or required before submission such that a provisional declaration may be saved and completed at a later date before submission.

The questions in the questionnaire may include one or more of a transit question, and a journey history question. The transit question is applicable for inbound travel, and allows the passenger to specify details associated with an outbound flight that they may take to leave the host country. The journey history question allows the passenger to build up a list of where they have been in the run-up to the journey associated with the travel declaration.

In preferred embodiments, the questions may take one or more of the following forms:
Yes/No—for a Yes/No question,
Options—for a single-select, drop-down question,
CSV—for a multi-select question,
Text—for a single-line text question,
Text area—for a multi-line text area question,
File—for a File Upload question.
Date—for question that requires a date to be entered.
Transit—for an outbound transit flight question, which asks for one or more of the following information: Departure port; Departure date; and Flight number.
Address—for an address collection question, which asks for one or more of the following information: Street Address; Town; State or Postcode; Country
Telephone—for a telephone number question, which asks for one or more of an international dialling code, and a number.
Journey History—for a list places visited prior to travel, which asks for one or more of Country code; City; Arrival date; and Departure date.
Country—for a question that requires a country to be input.
Compound—to define a tabular compound question. The compound question comprises one or more element questions that combine to create a table. The question that is the parent compound question references the other element questions, and they in turn reference the parent compound question.
Questions dependent on other questions. A particular question may be dependent on the answer to another question, and it is only displayed if the parent question has a fixed list of possible answers, and a selected one or more of those answers is selected.
Questions dependent on other attributes. Alternatively, the question may be dependent on one of the main attributes of the application, such as the age of the applicant, the applicant's nationality, and/or the issuing country of the applicant's travel document.

In step 314, the passenger completes the questionnaire in order to submit a travel declaration. In some embodiments, the system displays a confirmation screen allowing the traveller to verify their answers before submission.

The passenger may also submit any supporting documents to the authorisation application 230 in step 315 if required for the travel declaration. In steps 316 and 317, the authorisation application 230 stores the travel declaration and any supporting documents in the database 250.

In preferred embodiments, the answers in the declaration are returned as a list of objects with the following contents:
For a Yes/No question, this contains the values true or false.
For a single-select (Options) question, this is an option identifier.
For a multi-select question (CSV), the option identifiers are separated by a comma character.
For a file question, this contains the unique field.
For a date question, this contains the entered date in the YYYY-MM-DD format.
For a transit question, this contains transit information including one or more of:
   <internalPortId>, which indicates the name of the town or city where the passenger is due to enter the destination country;
   <DepartureDate>, which indicates the date of departure for the journey;
   <Flight>, which indicates the flight number associated with the journey;
   <DeparturePort>, which indicates the name of the town or city where the passenger is due to exit the destination country;
   <DepartureDateTime>, which indicates the date and time of departure from the destination country.
For an address question, this contains address information collected including one or more of:
   <StreetAddress>;
   <Town>;
   <State> or <Postcode> or <Zipcode>;
   <CountryCode>.
For a telephone question, this field contains the international dialling code, a space, and then the number.
For a Journey History, the answer is a comma-separated list, surrounded with
“[]”, of the form:
   [&quot; <CountryCode>; <City>; <departureDate>; <arrivalDate>&quot;]
For a country question, this field contains the 3 letter ICAO country code of the selected country.
For a compound parent question, the answer is encoded in JSON as a list of rows, with each row being a list of atomic question answer objects, each containing a QuestionId attribute and an Answer attribute.
For a compound element question, the answer is blank.

On receiving the travel declaration from the passenger, the authorisation system 200 then proceeds to analyse the answers to the set of configurable questions provided by the passenger in order to determine whether the passenger is authorised to undertake the planned journey to the destination country. In preferred embodiments, the authorisation application 230 applies a set of rules on the data provided by the passenger in order to perform the risk assessment in step 318. In some embodiments, the set of rules may result in the authorisation application 230 providing a submission confirmation to the passenger in step 319 that confirms receipt of the travel declaration.

Once all questions have been answered, the system makes a risk calculation based on the answers provided by the passenger in the following way.
1. For Yes/No type questions the scoring definition gives a score for a “Yes” answer. A No answer always scores zero.
2. Single-Selection type questions: The scoring definition gives a score for each option.
3. Multi-Selection type questions: The scoring definition gives a score for each option, which are then summed together.

The score for each question in the questionnaire is then summed, and the total score analysed. If the total score is greater than or equal to a first, Auto-Reject, threshold then the declaration is set to a Declined status, and a Declined email is sent to the applicant. Otherwise, if the score is greater than or equal to another, Manual-Assessment, threshold then the declaration is set to an Under Review status, and an Under Review email is sent to the applicant. Otherwise, if the score is less than the predetermined Manual-Assessment threshold the declaration is set to an Approved status, and an Approved email is sent to the applicant.

Accordingly, the risk assessment may involve comparing each answer to a set of stored risk parameters in order to allocate a score for each answer provided by the passenger. The individual scores may then be summed to produce a total score that may then be compared to a predetermined threshold value in order to provide an authorisation outcome. The predetermined threshold value may represent a decision boundary, whereby if the answers provided by a passenger do not result in a total score that meets the threshold then the passenger is not authorised to travel. In such instances the system may mark the health declaration as “Declined” and sends a notification or email to the passenger indicating that their application has been declined. For example, if the system calculates a risk score that equals or exceeds a configurable “auto-reject” score, then the system issues an authorisation outcome of “Declined” and emails the passenger.

Alternatively, if the calculated score is below the predetermined threshold value the passenger journey is approved. In preferred embodiments, an email is sent to the passenger confirming the approved status of the passenger's declaration and a token enabling the user to retrieve the travel authorisation outcome and any documents associated with the travel declaration, including a travel authorisation document. In some embodiments, the token is a QR code or a unique reference number. In other embodiments, the confirmatory email also includes a copy of the travel authorisation document.

In some embodiments, a further threshold value may be provided whereby if the total score meets the predetermined threshold value, but does not meet the further threshold value, the travel declaration may be manually reviewed by an agent. In preferred embodiments, the further threshold value is configured such that declarations that are relatively low risk and are otherwise approved, but which do not convincingly exceed the predetermined threshold for authorising the passenger to travel, are subjected to further scrutiny by an agent who may decide whether or not the passenger is authorised to travel. In such instances, the system may mark the health declaration as “Under Review” and sends notification or email to the passenger indicating that their application is being reviewed further. In such embodiments, the passenger journey is approved if the calculated score is below the predetermined threshold value and the further threshold value.

Accordingly, the system determines a travel authorisation outcome based on the score calculated based on a comparison between the answers provided by the passenger and a set of risk parameters that determine the level of risk associated with a particular answer. In preferred embodiments, the travel authorisation outcome may be a status associated with a travel declaration and may be one of the following:
INCOMPLETE—issued for a declaration having some questions that are still to be answered before submission.
ACCEPTED—issued for a granted declaration
REJECTED—issued for a rejected declaration
MANUAL ASSESSENT—issued for a declaration that is waiting for an agent's decision.
EXPIRED—issued for a declaration that has expired.
PENDING DELETE—issued for a declaration that the traveller has requested to be deleted.

In a final step 320, the authorisation application 230 notifies the passenger of the travel authorisation outcome, for example by sending an email or a notification via the mobile application 211. If the passenger is authorised to travel then the notification may include a travel authorisation document that provides the passenger with authority to undertake the journey to the destination country.

It will be appreciated that the systems and methods described herein may apply to different types of travel authorisation document that authorise a passenger to make a journey to a destination.

As a first example, the travel authorisation document is a health declaration for determining whether the passenger is medically suitable for travel. Such health declarations may be required by governments during global health crises, such as the coronavirus disease Covid-19 pandemic.

In such instances where the travel authorisation document is a health declaration, the passenger may be issued with a set of questions that are configured to gather information associated with the passenger journey including one or more of: passenger-related information, such as a passenger name and date of birth; information associated with one or more health tests, such as information identifying a negative test for one or more diseases of interest within a predetermined period; information associated with one or more recent vaccinations, such as the date and vaccine administered to inoculate the passenger against a disease of interest; information associated with symptoms indicative of the one or more diseases of interest; and information associated with one or more pre-existing health conditions of the passenger.

Additionally, for health declarations the systems and methods described above may further involve anonymising information associated with the health declaration in order to preserve patient confidentiality. This may involve the information associated with the health declaration being deleted after a predetermined interval of time, for example 12 months.

In a second example, the travel authorisation document is a customs declaration for determining whether the passenger journey will incur customs duties. Such customs declarations are currently typically performed on landing cards on transit to the destination country.

In such instances where the travel authorisation document is a customs declaration, the passenger may be issued with a set of questions that are configured to gather information associated with the passenger journey including one or more of: passenger-related information, such as passenger name, nationality, date of birth, and home address; flight-related information, such as one or more flight numbers; information associated with value of goods being brought into the destination country; and information associated with controlled goods or substances subject to regulation by the arrival country.

In a third example, the travel authorisation document is an immigration declaration for determining the immigration status of the passenger. In such instances where the travel authorisation document is an immigration declaration, the passenger may be issued with a set of questions that are configured to gather information associated with the passenger journey including one or more of: the purpose of the passenger's visit; passenger-related information, such as nationality, the country that issued the passenger's travel document, and the passenger's country of residence.

An example travel authorisation document is shown in FIG. 4.

FIG. 4 shows a schematic diagram of an example travel authorisation document 400 that is a health declaration. As shown in FIG. 4, the health declaration includes indicia that indicate one or more of: an issuing country 410, a travel authorisation outcome or status 420, a unique identifier 430, passenger-related information 440, authentication document validity information 450, and journey-related information 460.

The issuing country indicia 410 indicates the country or government that has issued or approved the travel authorisation document. In the example shown in FIG. 4, the issuing country for the example travel authorisation document is Antarctica.

The travel authorisation outcome indicia 420 indicates the status of the passenger's health declaration, and if approved, indicates that the passenger is authorised to travel to the destination country.

The unique identifier indicia 430 provides one or more means of uniquely identifying the travel authorisation document. In the example shown in FIG. 4, the unique identifier indicia 430 includes a QR code 431 and a GUID 432. In preferred embodiments, the QR code and/or the GUID allow a user to access at least part of the passenger's passenger-related information and travel authorisation outcome on a database.

In preferred embodiments, the QR code on the travel authentication document contains a representation of a URL that can be used to view a summary of the declaration that is stored on database 250. The URL may be in the form:
https://gov.xx./health-declaration/b7e913e0-e5c0-4de7-9fe2-28e3b11189ae

Where the URL contains the unique GUID identifier for the declaration, the GUID in the above example being: b7e913e0-e5c0-4de7-9fe2-28e3b11189ae.

Any agent may then access a subset of information associated with the declaration or travel authentication document by scanning the QR code to open the URL to thereby display information that can be used to verify the current status of the travel declaration.

The passenger-related information indicia 440 indicates information associated with the passenger making the journey. In the example shown in FIG. 4, the passenger-related information includes the passenger's given name and family name, and an identification number associated with the passenger's travel document.

The authentication document validity information indicia 450 indicates information associated with the validity of the authentication document. In the example shown in FIG. 4, the authentication document validity information includes a UTC date and timestamp indicating when the passenger submitted the declaration, and a UTC date and timestamp indicating when the authentication document will expire.

Finally, the journey-related information indicia 460 indicates information associated with the journey being made, or to be made, by the passenger. In the example shown in FIG. 4, the journey-related information includes the mode of travel for the journey, the departure country, the departure date, the arrival port name, the name of the transportation vessel for the passenger journey, and an arrival date. In the example of FIG. 4, the passenger journey is scheduled to take place by sea on the polar research ship RRS Sir David Attenborough, departing from Australia on 22 Nov. 2021 and arriving at McMurdo Station on 22 Nov. 2021.

The above detailed description of embodiments of the invention are not intended to be exhaustive or to limit the invention to the precise form disclosed. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure.

1-47. (canceled)

48. A system for authorising a passenger journey from an origin country to a destination country, the system comprising:
a memory for storing computer readable code; and
a processor operatively coupled to the memory, the processor configured to:
issue a set of predetermined questions relating to the passenger journey to a passenger before travelling to the destination country;
receive information associated with the passenger journey;
calculate a score associated with the passenger journey by comparing the information associated with the passenger journey to one or more risk parameters;
compare the calculated score to a predetermined threshold value to determine a travel authorisation outcome; and
issue, based on the travel authorisation outcome, a travel authorisation document to the passenger making the passenger journey.

49. The system of claim 48, further comprising a mobile device including the memory for storing computer readable code, the processor operatively coupled to the memory, a display and a receiver.

50. The system of claim 48, wherein the passenger-related information includes one or more images of the passenger's face, wherein the one more images include live images or video of the passenger's face, and further comprising a passenger profile based on the passenger-related information, the passenger profile including one or more of passport data, live face image data, and digital travel credentials (DTD).

51. The system of claim 48, wherein the processor is further configured to authorise the passenger journey if the calculated score is less than the predetermined threshold value.

52. The system of claim 48, wherein the predetermined questions are a set of configurable questions related to the health, customs and/or immigration status of the passenger.

53. The system of claim 48, wherein the travel authorisation document is a health declaration for determining whether the passenger is medically suitable for travel, wherein the information associated with the health declaration is anonymised, wherein the information associated with the health declaration is deleted after a predetermined interval of time, and wherein the information associated with the passenger journey includes one or more of passenger-related information, information associated with one or more health tests, information associated with one or more recent vaccinations, information associated with symptoms indicative of one or more diseases, and information associated with one or more pre-existing health conditions.

54. The system of claim 48, wherein the travel authorisation document is a customs declaration for determining whether the passenger journey will incur customs duties, wherein the information associated with the passenger journey includes one or more of passenger-related information, flight-related information, information associated with value of goods being brought into arrival country, and information associated with controlled goods or substances subject to regulation by the arrival country.

55. The system of claim 48, wherein the travel authorisation document is an immigration declaration for determining the immigration status of the passenger.

56. The system of claim 48, further comprising a database for storing the information associated with the passenger journey, travel authorisation outcome and travel authorisation document in a database, and further comprising a token associated with the passenger journey, the token configured to allow a user to access at least part of the stored passenger-related information and travel authorisation outcome, wherein the token is a QR code, or a reference number, and wherein the stored passenger-journey information and travel authorisation outcome associated with the passenger journey are assigned a unique GUID.

57. The system of claim 48, wherein the information associated with the passenger journey includes passenger-related information, the system further comprising a browser application or mobile application for obtaining the information associated with the passenger journey, the system further comprising an optical character recognition (OCR) system for obtaining the passenger-related information from one or more travel identity documents associated with the passenger, the system further comprising a Near Field Communications (NFC) system for obtaining the passenger-related information from one or more travel identity documents associated with the passenger, and the system further comprising a check-in system configured to prevent the passenger from checking in for the journey if authorisation for the passenger journey is denied.

58. A method for authorising a passenger journey from an origin country to a destination country, the method comprising:
issuing, to a passenger before travelling to the destination country, a set of predetermined questions relating to the passenger journey;
receiving, in response to the set of questions, information associated with the passenger journey;
calculating a score associated with the passenger journey by comparing the information associated with the passenger journey to one or more risk parameters;
comparing the calculated score to a predetermined threshold value to determine a travel authorisation outcome; and
issuing, based on the travel authorisation outcome, a travel authorisation document to the passenger thereby enabling the passenger to undertake the passenger journey.

59. The method of claim 58, further comprising authorising the passenger journey if the calculated score is less than the predetermined threshold value.

60. The method of claim 58, further comprising storing the information associated with the passenger journey, travel authorisation outcome and travel authorisation document in a database, and further comprising issuing a token associated with the passenger journey for allowing a user to access at least part of the stored passenger-related information and travel authorisation outcome, wherein the token is a QR code, or a reference number, and wherein a unique GUID is assigned to the stored passenger-journey information and travel authorisation outcome associated with the passenger journey.

61. The method of claim 58, further comprising obtaining, via a browser application or mobile application, the information associated with the passenger journey.

62. The method of claim 58, further comprising obtaining, via an optical character recognition (OCR) system, the passenger-related information from one or more travel identity documents associated with the passenger.

63. The method of claim 58, further comprising obtaining, via a Near Field Communications (NFC) system, the passenger-related information from one or more travel identity documents associated with the passenger.

64. The method of claim 58, further comprising obtaining the passenger-related information via a mobile device, the passenger-related information including one or more images of the passenger's face, wherein the one more images include live images or video of the passenger's face, further comprising verifying the passenger based on the passenger-related information, and further comprising creating a passenger profile based on the passenger-related information, the passenger profile including one or more of passport data, live face image data, and digital travel credentials (DTD).

65. The method of claim 58, further comprising obtaining, via one or more external systems, the information associated with the passenger journey, the one or more external systems including a passenger name record (PNR), check in system, flight information system, or a health declaration system.

66. The method of claim 58, wherein the travel authorisation document is transmitted via a mobile application, email, SMS, or other suitable means of communication.

67. The method of claim 58, further comprising authenticating the passenger using a personal identification number (PIN) and/or biometric data associated with the passenger, and further comprising associating the PIN and/or biometric data with a token associated with the passenger journey.
